(19) United States
(12) Patent Application Publication
(10) Pub. No.: US 2007/0132560 A1
(43) Pub. Date: Jun. 14, 2007

(54) Coupling alignment system

(76) Inventors: Mark W. Nystrom, Telluride, CO (US); Patrick J. Nystrom, Corbett, OR (US)

Correspondence Address: COX SMITH MATTHEWS INCORPORATED, 112 EAST PECAN STREET, SUITE 1800, SAN ANTONIO, TX, 78205-1521, US

(21) Appl. No.: 11/298,929

(22) Filed: Dec. 9, 2005

(51) Int. Cl. G08B 21/00

(52) U.S. Cl. 340/431; 340/686.2

(57) ABSTRACT

An apparatus for aligning a tow vehicle and a trailer having a scanner mounted on or near the bumper of the tow vehicle, one or more targets on or near the trailer hitch, and a display device inside the tow vehicle cabin. The scanner emits a laser beam which is scanned across the target area. The target reflects most of the laser energy back along the beam to the scanner. A photodetector in the scanner measures the reflected beam and determines distance and position of the target by accurately measuring timing of the reflected pulses. Distance and position information is conveyed to the display device, which, in turn, indicates to the driver the relative position of the tow vehicle with respect to the trailer.

### BACKGROUND OF THE INVENTION

1. Field of the Invention

The present invention is directed toward an apparatus for quick, accurate coupling of a hitch between a tow vehicle and a trailer. In particular, the present invention provides a device having a scanner mounted on or near the bumper of the tow vehicle, a target on or near the trailer hitch, and a display device inside the tow vehicle cabin.

2. Background Information

Since its invention, the automobile has been used to transport goods throughout the nation's roads and highways. Most significantly in its development, the automobile has been used to tow trailers loaded with almost any good one could imagine. From the independent farmer towing a trailer load of hay, to the weekend sportsman towing his fishing boat to the lake, Americans increasingly depend on their trucks and sports utility vehicles to pull a trailer, whether for business or pleasure. Accordingly, this activity leads to the necessary function of hitching a tow vehicle to a trailer, a task which, prior to the present invention, required tremendous skill and/or patience on the part of the driver.

As anyone that has ever tried knows, hitching a trailer of any sort to a tow vehicle is a difficult task to say the least. The most rudimentary, yet probably the most popular current method of hitching a trailer requires at least two people. This requires one person outside of the vehicle (a spotter) to direct the driver as to which direction the tow vehicle needs to be maneuvered in order to guide the vehicle in line with the trailer hitch. Even less efficient, but all to often necessary, is the case when the only person available is the driver, who must repeatedly get into and out of the vehicle in order to get the required feedback to dock the tow vehicle with the trailer. Of course, the difficulty and tediousness of the task increases with the onset of inclement environmental conditions. All of this leads to the inevitable, trailer or tow vehicle damage from accidental collision during repeated docking attempts and maybe most significantly frustration on the part of the driver.

Over the years many have attempted to solve this problem through a variety of technologies with little commercial success. Inventions in this field range from the simplistic to the exceedingly complex. For example, Lockwood (U.S. Pat. No. 5,669,621) discloses a simplistic approach to docking a tow vehicle with a trailer involving a combination of flags, which guide the driver to the location for proper hitching. Of course, the accuracy of such a system is limited to the visibility conditions as well as the skill and experience of the driver. On the other end of the spectrum is Capik et al. (U.S. Pat. No. 6,176,505), which requires a combination of two different colored light sources that intersect when the tow vehicle and trailer are aligned. Again, this system is clearly limited to optimal visibility conditions, such that the colored lights are actually visible to the driver. Finally, the closest prior art to the present invention is embodied in an alternative system disclosed in Capik et al., wherein a light source mounted on the trailer projects downward onto a sensor plate surrounding the trailer hitch on the tow vehicle. The location is then relayed into the cabin to guide the driver. This device increases the complexity and cost of the system, not only by requiring a significantly complex sensor plate filled with photoelectric sensors, but it also requires an external power source to power the light source stationed on the trailer. Furthermore, the alternative Capik et al. system fails to provide any feedback to the driver until the driver is within the zone of the sensor plate, which in practice, may only be a few inches.

In view of the limitations of products currently known in the art, a tremendous need exists for a vehicle coupling alignment device that facilitates quick, accurate coupling of a hitch between a tow vehicle and a trailer. Applicant's invention, by its novel design provides a solution in view of currently available devices.

### SUMMARY OF THE INVENTION

In view of the foregoing, it is an object of the present invention to provide a device for tow vehicle coupling alignment that allows the driver to stay inside of the cabin of the tow vehicle throughout the alignment process.

It is another object of the present invention to provide a device for tow vehicle coupling alignment that involves only the driver of the tow vehicle.

It is another object of the present invention to provide a device for tow vehicle coupling alignment that is extremely accurate.

It is another object of the present invention to provide a device for tow vehicle coupling alignment that is functional in all lighting conditions.

It is another object of the present invention to provide a device for tow vehicle coupling alignment that is functional in all weather conditions.

It is another object of the present invention to provide a device for tow vehicle coupling alignment that is inexpensive.

It is another object of the present invention to provide a device for tow vehicle coupling alignment that is durable.

It is another object of the present invention to provide a device for tow vehicle coupling alignment that provides immediate feedback to the driver.

It is another object of the present invention to provide a device for tow vehicle coupling alignment that is dependable.

It is another object of the present invention to provide a device for tow vehicle coupling alignment that is functional in any visibility condition.

It is another object of the present invention to proved a device for tow vehicle coupling alignment that provides feedback at a significant distance.

In satisfaction of these and other related objectives, the present invention provides a device for tow vehicle coupling alignment. This invention facilitates quick, accurate coupling alignment between a tow vehicle and a trailer by a single driver of the tow vehicle without leaving the cabin. As will be discussed in the specification to follow, practice of the present invention involves a combination of components to provide immediate feedback of the relative location between the tow vehicle and trailer throughout the docking process.

The preferred embodiment of the present invention incorporates a scanner mounted on or near the bumper of the tow vehicle, one or more targets on or near the trailer hitch, and a display device inside the tow vehicle cabin. The scanner emits a laser beam, which is scanned horizontally across the target area. The target consists of retro-reflective material, which reflects most of the laser energy back along the beam to the scanner. A photodetector in the scanner measures the reflected beam and determines the location of the target by accurately measuring the timing of the reflected pulses. The location information is conveyed to the display device digitally by means of Radio Frequency (RF) energy delivered either over the tow vehicle's wiring system or by near field radiation. The display device is a small flat panel display consisting of a cross-hair of light emitting diodes (LED), which indicate distance on the vertical axis and left/right position on the horizontal axis. A separate LED indicates when position information cannot be determined for indicating to the driver that the scanner lens needs cleaning, and the display device may also contain a speaker which emits tones to assist the driver in the alignment process.

### BRIEF DESCRIPTION OF THE DRAWINGS

Applicant's invention may be further understood from a description of the accompanying drawings, wherein unless otherwise specified, like referenced numerals are intended to depict like components in the various views.

FIG. 1 is a top plan view of the apparatus of the present invention as installed on a tow vehicle/trailer combination.

FIG. 2 is a front, cross-sectional view representing the functionality of the scanner of the present invention.

FIG. 3 is a schematic of the scanner circuit board of the present invention.

FIG. 4 is side view of the display device of the present invention.

FIG. 5 is a front view of the display device of the present invention.

FIG. 6 is a schematic of the display device electronics of the present invention.

FIG. 7 is a side, cross-sectional view of an alternate embodiment of the scanner mounting device of the present invention.

FIG. 8 is a front, cross-sectional view of an alternate embodiment of the scanner mounting device of the present invention.

### DETAILED DESCRIPTION OF THE PREFERRED EMBODIMENT

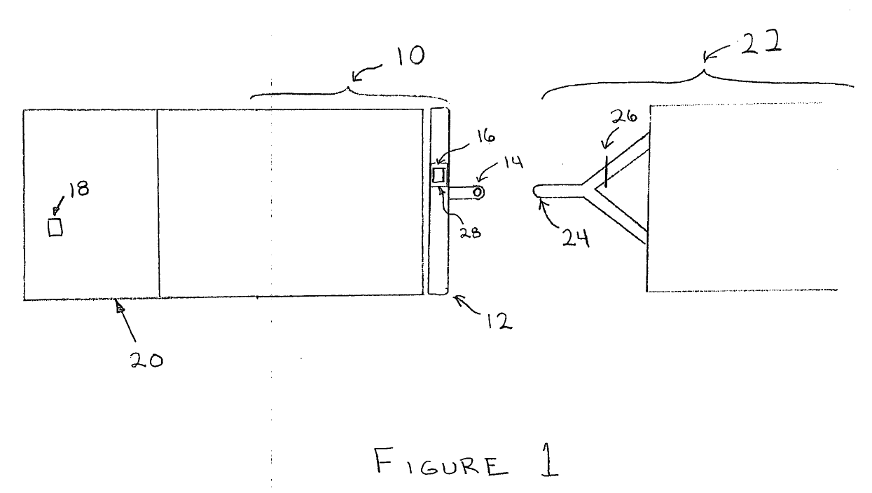

Referring to FIG. 1, an overview of an apparatus for aligning a tow vehicle 10 and a trailer 22 is shown as installed in the preferred embodiment. Tow vehicle 10 has a bumper 12 and a ball hitch 14. Scanner 16 is removably mounted to bumper 12 either directly or via optional bracket member 28, and display device 18 is removably mounted in tow vehicle cabin 20. Trailer 22 has a ball receiver 24, which must couple with ball hitch 14. Target 26 is mounted in proximity to ball receiver 24. In operation, scanner 16 sweeps a laser beam across target 26, and using reflected energy from target 26, scanner 16 determines its relative position to target 26. Scanner 16 is pre-programmed with relative offset positioning between target 26 and ball receiver 24 as well as offset positioning between scanner 16 and ball hitch 14, such that the exact position of ball hitch 14 relative to ball receiver 24 is determined. Scanner 16 then sends a signal to display device 18 either by radiating an RF signal or via existing tow vehicle 10 wiring to display the determined relative positioning.

As previously mentioned, scanner 16 may either be directly mounted to tow vehicle bumper 12 via either permanent or temporary means as known in the art. Alternatively, bracket 28 may be permanently mounted to tow vehicle bumper 12, such that scanner 16 may be removably attached to bracket 28 in any number of methods and configurations as would be obvious to one skilled in the art.

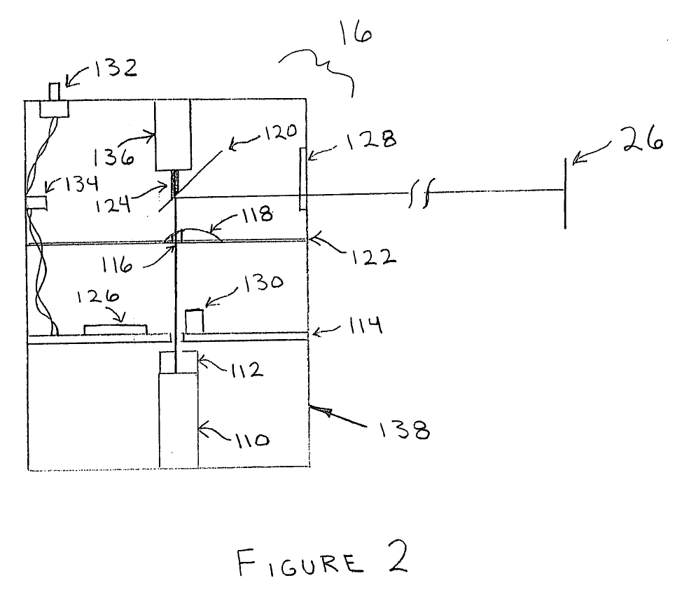

A diagrammatical view of the preferred embodiment of scanner 16 and its method of operation is presented in FIG. 2. Referring to FIG. 2, laser 110 is mounted to scanner enclosure 138 and emits a beam through collimator 112 and circuit board 114. Laser 110, in the preferred embodiment, is a low-power semiconductor laser operating at a wavelength of 635 nm and a power of 1 mw. Such lasers are common in hand-held pointing devices. Further, in the preferred embodiment, collimator 112 is a molded plastic or rubber part, which fits over the end of laser 110 and blocks extraneous radiation form the beam path. Collimator 112 is essentially a solid cylinder of light-absorbing material having a matte black finish with a hole of the appropriate beam size drilled through its center. Semiconductor lasers, such as that used in the preferred embodiment of the present invention, typically produce an elliptical spot with some scattered radiation around the beam. Collimator 112 blocks all but the center of the beam thereby reducing non-aligned light energy and reducing the size of the beam which strikes target 26. Correspondingly, the smaller the beam size which can be achieved at target 26, the more accurately the beam's entry and exit times can be ascertained.

Still referring to FIG. 2, the beam next passes through hole 116 in lens 118 and onto mirror 120. Lens 118, in the preferred embodiment, is an inexpensive plastic type lens such as those used in disposable cameras. Hole 116 in lens 118 allows the laser beam to pass through the lens without being refracted by the lens. If the laser beam were to pass through the lens material, it would disperse and fail to accomplish its function of detecting target 26. Mirror 120 is a front-surface mirror which reflects the laser beam toward target 26 and moves the beam across target 26. Mirror 120 can be rectangular or elliptical; however, mirror 120 must be sized and shaped to match that of lens 118 such that paraxial rays projected upward from lens 118 all strike mirror 120.

Lens 118 is suspended by lens bracket 122, which is mounted onto scanner enclosure 138. Mirror 120 is attached to spindle 124 of motor 136, which is also mounted to enclosure 138. Motor 136, in the preferred embodiment, is a small DC motor with appropriate gearing such that the output shaft rotates between 300 and 600 rpm, depending on the voltage applied. Motor 136 rotates mirror 120 such that the laser beam is swept 360 degrees at an appropriate speed. A beam position sensor in the form of photodiode 134 is mounted in the path of the beam inside scanner 16 and allows processor 126 to calculate the exact position of the beam at any particular point in time. The beam then exits scanner 16 through window 128 and scans across target 26. Target 26 is a retro-reflective surface which reflects light back along its angle of incidence.

At this point, energy is reflected back to scanner 16 through window 128 to mirror 136. In the preferred embodiment, window 128 is constructed of a transparent material as known in the art such as an appropriate plastic or glass. Window 128 allows the laser beam to exit scanner 16 as well as allow the reflected energy back into scanner 16 while sealing with scanner enclosure 138 to protect the inside of scanner 16 from environmental contamination. Mirror 136, next, reflects the returned energy from target 26 toward lens 118. Lens 118 collects the laser energy returned from target 26 and focuses it on photodiode 130, which is mounted to circuit board 114. The diameter of lens 118 limits the sensitivity of scanner 16, in that, the greater lens 118 aperture, the more light energy it delivers to photodiode 130; hence, the greater the diameter of lens 118, the more distant target 26 that scanner 16 can detect. However, Applicant has established that a lens 118 of smaller than ½ inch diameter adequately collects light from target 26 at twenty feet. Additionally, the beam must initially pass through hole 116 in lens 118 as closely as possible to the optical axis of lens 118 since most of the reflected energy will travel back along the beam path and since the intensity of the reflected energy drops off quickly as photodiode 130 is moved off of the beam axis. Therefore, since photodiode 130 must be on the optical axis, hole 116 must be located just slightly off-center in lens 118. This allows the beam to be placed as closely as possible to the optical axis of lens 118; thus, the maximum intensity of reflected energy is delivered back to photodiode 130.

In the preferred embodiment, photodiode 130 is a PIN photodiode, which is sensitive to red and infrared energy. When properly biased, photodiode 130 converts light energy into electrical current in proportion to the light intensity. Next, circuitry on circuit board 114 amplifies the reflected energy, converts the reflected energy to pulses, measures the timing of the pulses, and calculates the relative distance and offset between ball hitch 14 and ball receiver 24.

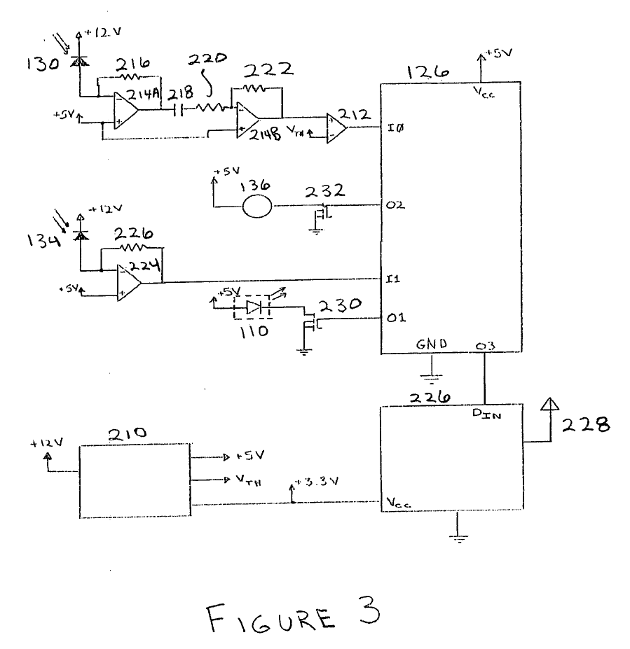

Further, circuit board 114 contains the circuitry required to control the laser and motor as well as receive, process, and relay position information. The functionality of circuit board 114 is represented in the electrical schematic of FIG. 3. Referring to FIG. 3, simple power supply circuit 210 takes as its input the +12 to +15V potential generated by the tow vehicle's electrical system and generates outputs +5V, +3.3V, and Vth. Alternatively, scanner 16 may be powered by an internal battery; thus, installation would be simplified by eliminating any connection to tow vehicle 10 existing electrical system. Vth is used by comparator 212 and is an adjustable sensitivity setting. Processor 126 has outputs O1-O3 and inputs I0 and I1. Processor 126 is powered by output +5V of power circuit 210. Processor 126 has an internal oscillator and reset circuit. Output O1 controls the gate of N-channel MOSFET Q1, the drain of which is connected to laser 110. Output O1 acting through N-channel MOSFET Q1 allows processor 126 to switch the laser beam on and off. A similar circuit is formed with output O2 and N-channel MOSFET Q2, which allows processor 126 to turn motor 136 on and off as well as control motor 136 speed. Speed control is accomplished by pulsing output O2 on and off several hundred times per second. The on- to off-time ratio, or duty cycle, controls the motor 136 speed of rotation. Reflected laser energy form target 26 is focused onto photodiode 130 which is reverse biased into the virtual ground at the inverting input of operational amplifier 214. 214A and 214B are separate amplifier stages in the same chip. Current proportional to the received energy is impinged on inverting input 214A, whose output supplies enough current to offset photodiode 130 current. Feedback resistor 216 converts this current into a voltage proportional to the received light energy. Capacitor 218 blocks the DC component of this voltage which will be the sum of ambient light and offset errors of operational amplifier 214 and is not of interest to the remainder of the circuit. When laser 110 is scanning across target 126, there is be a rapid pulse of light reflected from target 26; this rapid pulse is the only signal of interest to the functionality of scanner 16. Operational amplifier 214B, resistor 216, and resistor 222 form an inverting amplifier which amplifies the voltage pulse form operational amplifier 214A to a convenient level for comparison by comparator 212. Comparator 212 compares the amplified voltage pulse to a reference voltage produced by power circuit 210. If the size of the voltage pulse exceeds the reference voltage, the output of comparator 212 goes high and can be read as a logic ‘1’ by processor 126 via input 10.

Still referring to FIG. 3, photodiode 134 is placed in the beam path inside scanner 16 such that once per rotation of mirror 120, the beam falls directly on photodiode 134. Operational amplifier 224 and resistor 226 are similar in function to operational amplifier 214A and resistor 216, forming a current-to-voltage converter. The signal is very large from this stage relative to the output of operational amplifier 214A since the beam's entire energy will fall on photodiode 134; therefore, no further amplification of the signal is necessary before this signal is fed to processor 126 via input I1. The input at input I1 will be normally logic ‘1’ until the beam scans across photodiode 134, at which time it will pulse to logic ‘0’. Processor 126 uses this pulse as a beam position index. The timing between successive pulses allows the processor 126 to exactly determine the rotational period of the beam and its angular velocity as well as its exact position in the scan pattern when the beam enters and exits target 26. This knowledge allows processor 126 to determine the distance and position of target 26 since processor 126 is programmed to know the exact width of target 26.

Once processor 126 has determined the left-right position and distance of target 26, it converts this information into a short sequence of digitally encoded pulses which are sent via output O3 to RF transmitter 226. RF transmitter 226 is a low-power RF transmitter which operates in the 418 MHz band. A small antenna 228 is attached to RF transmitter 226 which allows it to radiate its RF signal to display device 18 inside tow vehicle cabin 20. Alternatively, information may be transmitted from scanner 16 to display device 18 by sending low-level RF over the existing wiring system of tow vehicle 10.

Referring back to FIG. 2, in the preferred embodiment, pushbutton 132 serves two functions. First, when scanner 16 is inactive, pushing pushbutton 132 activates scanner 16, at which time the laser beam begins scanning target 26 and transmitting data to display device 18. Secondly, when scanner 16 is active, pushing and holding pushbutton 132 for two seconds or longer will store the present target 26 location as the ‘home’ position. This information is stored in the form of two offsets, one for left-right distance and one for back-front distance, into non-volatile memory within processor 126. Referring back to FIG. 1, in operation, this procedure should be performed once after scanner 16 is mounted to tow vehicle bumper 12 and with trailer 22 already coupled to tow vehicle 10. Hence, the system ‘learns’ the target 26 mounting location relative to ball receiver 24 and can determine how far ball hitch 14 is from its coupled position with ball receiver 24.

Referring to FIG. 4, in the preferred embodiment, display device 18 consists of display panel 310, visor clip 312, power cable 314, and power connector 316. Display panel 310 attaches to a rearview mirror or visor in tow vehicle cabin 20 via visor clip 312. Power cable 314 runs from display panel 310 to 12V power connector 316, which, in turn, plugs into an existing power receptacle in tow vehicle cabin 20.

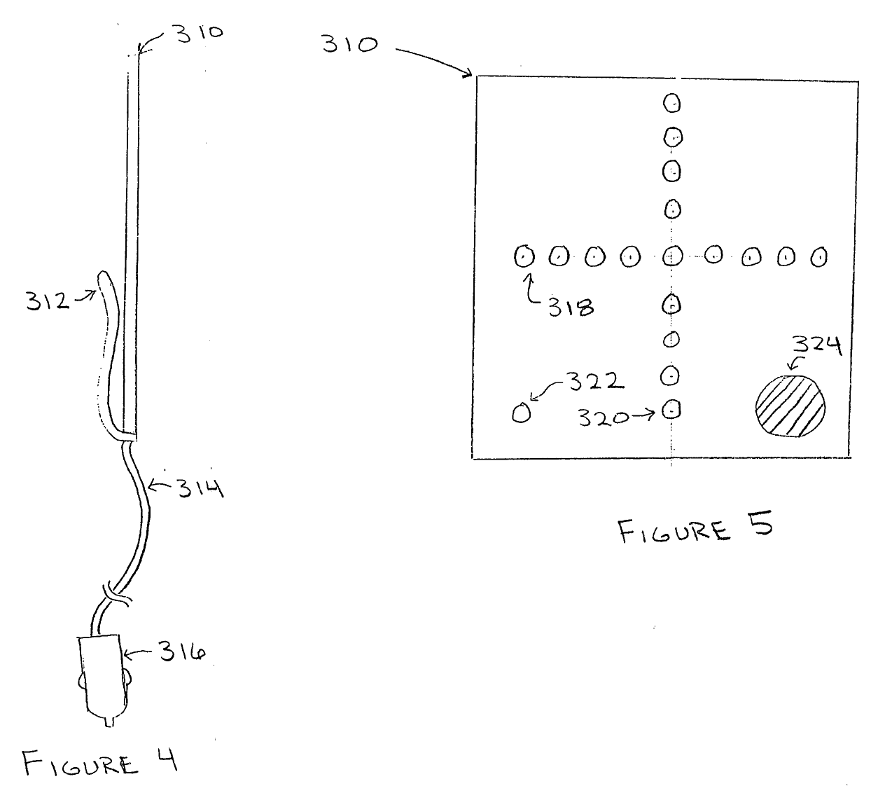

Referring to FIG. 5, display device 310 contains a row of horizontal LED' 318 to indicate the left/right position of ball receiver 14 relative to ball hitch 24, and a column of vertical LED's 320 to indicate front/back distance between ball receiver 14 and ball hitch 24. Additionally, fault LED 322 is included as a safety feature to indicate when position can not be determined. Lastly, speaker 324 emits tones to assist driver in aligning ball receiver 14 and ball hitch 24.

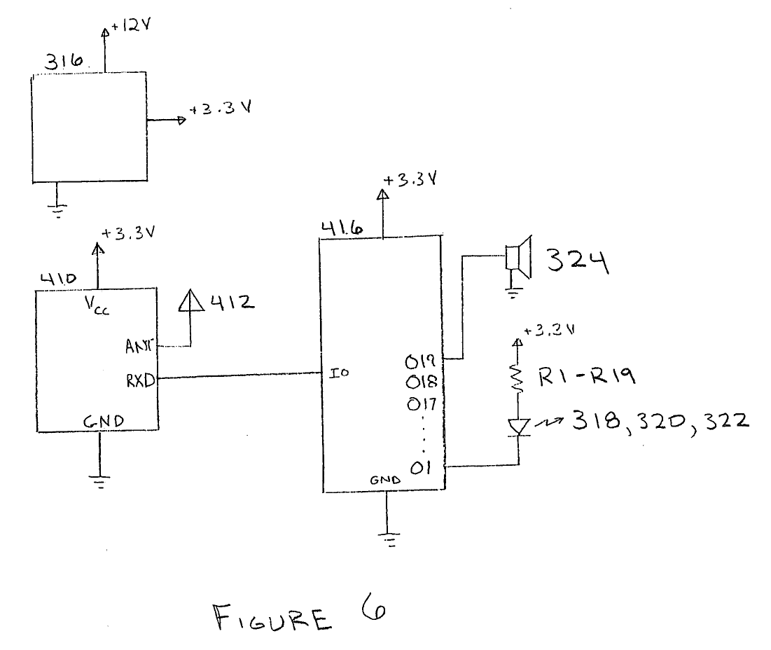

Referring to FIG. 6, an electrical schematic of display device 18 is provided. Power connector 316 connects to the 12V to 15V potential of tow vehicle's 10 electrical system by plugging into a power socket inside tow vehicle cabin 20 and generates the lower operating voltage required by display device 18 circuitry, such as +3.3V. RF receiver module 410 receives radio transmissions in the 418 MHz band via antenna 412. The received digital bitstream comes out of the RXD pin of RF receiver module 410 and connects to input I0 of processor 416. When a data packet is detected, it is decoded by software in processor 416 which drives the appropriate outputs O1-O19 to light LED's 318, 320, 322 and/or speaker 324. LED's 318, 320 and 322, in the preferred embodiment, are typical small LED's which require less than 15 mA of drive current. Resistors R1-R18 are current limiters of an appropriate value to limit the current through the associated LED's 318, 320, and 322. Output O19 connects to speaker 324 and directly controls the pitch and duration of any tones, which are appropriate to help the driver align tow vehicle 10 and trailer 12 based upon information received from scanner 16 via the radio link.

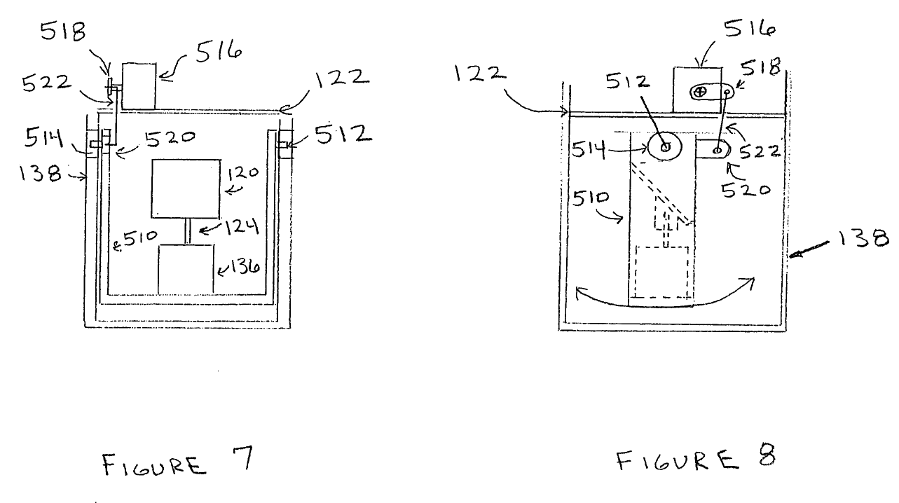

An alternative embodiment of motor 136/mirror 120 mounting system is portrayed in FIGS. 7 and 8, in which the beam can be positioned vertically as it scans horizontally allowing more flexibility in mounting target 26 and allowing greater variation in functional elevation between tow vehicle 10 and trailer 22. Referring to FIGS. 7 and 8, motor 136 connects to mirror 120 via spindle 124. In this alternate embodiment, this assembly sits in motor cradle 510. Motor cradle 510, in turn, is mounted to scanner enclosure 138 via hinge pins 512 rotatably engaged with bushings 514, which are embedded in scanner enclosure 138. Micro servo 516 is mounted to lens bracket 122. Micro servo 516 has rotating control horn 518, which couples to motor cradle control horn 520 via control linkage 522, which passes through hole in lens bracket 122. In operation, as mirror 120 rotates, sweeping the beam horizontally, changes in the position of micro servo control horn 518 cause motor cradle 510 to swing forward or backward, causing the beam to sweep up or down.

Typical use of the above described invention is envisioned as follows. First, initial setup and programming of the system must take place assuming the system has already been installed. This is accomplished by first aligning and coupling ball hitch 14 of tow vehicle 10 with ball receiver 24 of trailer 22. Next, pushbutton 132 must be pressed to activate scanner 16. Pushbutton 132 must then be pressed and held for two seconds to store the present target 26 location as the home position. The system is now programmed and ready for operation.

After tow vehicle 10 and trailer 22 have been disconnected and separated, the present invention may then be used for successive alignment for coupling. At this point, the driver plugs display device 18 into a 12V receptacle in tow vehicle cabin 20 and begins backing tow vehicle 10 for alignment with trailer 22. As scanner 16 detects target 26, a signal is transmitted to display device 18 in cabin 20, which both visually and audibly indicates to driver the relative location of ball receiver 24 with respect to ball hitch 14. The driver merely reacts to the indicators maneuvering tow vehicle 10 until display device 18 indicates alignment has been successful. At this point, tow vehicle 10 and trailer 22 have been properly aligned and are ready for coupling.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

I claim:

1. An apparatus for aligning two objects, comprising:
a scanner member, said scanner member being configured for reversible attachment to
a first object, said scanner member comprising:
an enclosure;
a light source, said light source being configured for projecting an initial beam of light, said light source being configured for mounting in said enclosure;
a light sensing member, said light sensing member being configured for receiving a reflected beam of light, said light sensing member being configured for converting said reflected beam of light into electrical current in proportion to the intensity of said reflected beam of light, said light sensing member being configured for mounting in said enclosure;
a processing member, said processing member being configured for controlling said light source, said processing member being configured for receiving said electrical current and converting said electrical current into digital data, said processing member being configured for mounting in said enclosure; and
a transmitting member, said transmitting member configured for receiving and transmitting said digital data;
a target member, said target member being configured for attachment to a second object, said target member being configured for reflecting said initial beam of light received from said light source back along its angle of incidence for reception by said light sensing member; and
a display device, said display device being configured for receiving said digital data from said transmitting member, said display device being configured for interpreting said digital data and indicating relative position of said second object with respect to said first object.

2. The apparatus of claim 1 wherein said first object is a tow vehicle and said second object is a trailer.

3. The apparatus of claim 2 wherein said digital data is transmitted via said tow vehicle's existing wiring system.

4. The apparatus of claim 2 wherein said scanner member is powered via said tow vehicle's existing power system.

5. The apparatus of claim 1 wherein said digital data is transmitted via a radio link between said transmitting member and said display device.

6. The apparatus of claim 1 wherein said scanner member is powered via an internal battery.

7. The apparatus of claim 1 wherein said display device indicates said relative position of said second object with respect to said first object via visual display.

8. The apparatus of claim 7 wherein said display device further indicates said relative position of said second object to said first object via audible means.

9. An apparatus for aligning two objects, comprising:
a scanner member, said scanner member being configured for reversible attachment to
a first object, said scanner member comprising:
an enclosure;
a light source, said light source being configured for projecting an initial beam of light, said light source being configured for mounting in said enclosure;
a motor, said motor being configured for mounting in said enclosure;
a mirror, said mirror being configured for attachment to said motor, said motor and said mirror combination being configured to sweep said initial beam of light as said mirror rotates with said motor output;
a first light sensing member, said first light sensing member being configured for receiving a reflected beam of light, said first light sensing member being configured for converting said reflected beam of light into a first electrical current in proportion to the intensity of said reflected beam of light, said light sensing member being configured for mounting in said enclosure;
a second light sensing member, said second light sensing member being configured to receive said sweep of said initial beam of light, said second light sensing member being configured for converting said sweep of said initial beam of light into a second electrical current, said second light sensing member being configured for mounting in said enclosure;
a processing member, said processing member being configured for controlling said light source, said processing member being configured for controlling said motor, said processing member being configured for receiving said first and second electrical current and converting said first and second electrical current into digital data, said processing member being configured for mounting in said enclosure; and
a transmitting member, said transmitting member configured for receiving and transmitting said digital data;
a target member, said target member being configured for attachment to a second object, said target member being configured for reflecting said initial beam of light received from said light source back along its angle of incidence for reception by said light sensing member; and
a display device, said display device being configured for receiving said digital data from said transmitting member, said display device being configured for interpreting said digital data and indicating relative position of said second object with respect to said first object.

10. The apparatus of claim 9 wherein said first object is a tow vehicle and said second object is a trailer.

11. The apparatus of claim 10 wherein said digital data is transmitted via said tow vehicle's existing wiring system.

12. The apparatus of claim 10 wherein said scanner member is powered via said tow vehicle's existing power system.

13. The apparatus of claim 9 wherein said digital data is transmitted via a radio link between said transmitting member and said display device.

14. The apparatus of claim 9 wherein said scanner member is powered via an internal battery.

15. The apparatus of claim 9 wherein said display device indicates said relative position of said second object with respect to said first object via visual display.

16. The apparatus of claim 15 wherein said display device further indicates said relative position of said second object with respect to said first object via audible means.

17. The apparatus of claim 9 wherein said scanner member is further comprised of:
a mounting member, said mounting member being configured to rotatably attach to said enclosure, said mounting member being configured for mounting of said motor;
a servo member; and
a connecting member, said connecting member linking said servo member and said mounting member such that angular changes in said servo member translate to angular changes in said mounting member.

18. The apparatus of claim 17 wherein said first object is a tow vehicle and said second object is a trailer.

19. The apparatus of claim 18 wherein said digital data is transmitted via said tow vehicle's existing wiring system.

20. The apparatus of claim 18 wherein said scanner member is powered via said tow vehicle's existing power system.

21. The apparatus of claim 17 wherein said digital data is transmitted via a radio link between said transmitting member and said display device.

22. The apparatus of claim 17 wherein said scanner member is powered via an internal battery.

23. The apparatus of claim 17 wherein said display device indicates said relative position of said second object with respect to said first object via visual display.

24. The apparatus of claim 17 wherein said display device further indicates said relative position of said second object with respect to said first object via audible means.
